(19) United States
(12) Patent Application Publication
(10) Pub. No.: US 2025/0332461 A1
(43) Pub. Date: Oct. 30, 2025

(54) COATING FOR DECONTAMINATION OF TOXIC CHEMICAL COMPOUNDS

(71) Applicants: COMMISSARIAT À L'ENERGIE ATOMIQUE ET AUX ENERGIES ALTERNATIVES, Paris (FR); HOWA TRAMICO, Brionne (FR)

(72) Inventors: Benoit BLONDEL, Grenoble (FR); Nelly RAMEAU, Grenoble (FR); Stéphane CADRA, Grenoble (FR); Stéphane BACOUP, Brionne (FR); Vincent BONNEROT, Brionne (FR); Laurent MOUGNARD, Brionne (FR)

(73) Assignees: COMMISSARIAT À L'ENERGIE ATOMIQUE ET AUX ENERGIES ALTERNATIVES, Paris (FR); HOWA TRAMICO, Brionne (FR)

(21) Appl. No.: 19/194,628

(22) Filed: Apr. 30, 2025

(30) Foreign Application Priority Data
Apr. 30, 2024 (FR) 24/04534

(51) Int. Cl. A62D 3/33; A62D 101/02; A62D 101/26; B01J 20/20; B01J 20/28; B01J 20/32; B32B 5/18; B32B 15/09; B32B 15/20; B32B 27/36

(52) U.S. Cl. CPC A62D 3/33; B01J 20/20; B01J 20/28035; B01J 20/28045; B01J 20/3212; B01J 20/3225; B01J 20/324; B01J 20/3297; B32B 5/18; B32B 15/09; B32B 15/20; B32B 27/36; A62D 2101/02; A62D 2101/26; B32B 2255/102; B32B 2255/26; B32B 2260/02; B32B 2260/04; B32B 2264/108; B32B 2266/0278; B32B 2307/724; B32B 2439/00

(57) ABSTRACT

A decontamination coating and method for manufacturing the decontamination coating, wherein the decontamination coating includes a multilayer structure including a support, a trapping layer intended to be brought into contact with the toxic chemical compounds so as to trap them, and a holding film intended to maintain the shape of the support in the plane and in a direction transverse to the plane, during the formation of the trapping layer.

### TECHNICAL FIELD OF THE INVENTION

The present invention relates to the field of decontamination of surface contaminated by toxic chemical compounds. In particular, the present invention concerns a decontamination coating intended to trap toxic chemical compounds. According to a second aspect, the present invention relates to a decontamination assembly comprising the decontamination coating and a dedicated packaging device. According to a third aspect, the present invention relates to a method for manufacturing said decontamination coating. The toxic compounds may be organophosphorus chemical compounds and the invention may find application in the decontamination of media comprising organophosphorus chemical compounds, for example, in some environments, such as the chemical industry, agriculture or even in sectors for combating chemical gas attacks, such as gases derived from G and V-type combat organophosphorus compounds.

These compounds can be included in the formulation of insecticides, pesticides or even chemical combat agents and are typically in the form of water-soluble oily organic compounds which, once dispersed in the environment, have a half-life in water ranging from 5 hours to 80 hours, with however the risk that the products of degradation by hydrolysis in water remain toxic for a period of 30 to 60 days.

### PRIOR ART

Given their toxicity, much research has been undertaken to develop curative solutions to the threats related to organophosphorus compounds. One of the focuses of this research is to find systems for trapping and/or degrading these compounds, in order to quickly make them inactive. These decontamination systems are generally in the form of liquids or powders used in the form of sprays or even in the form of hydrogel which will be able to integrate, through natural diffusion and natural miscibility, the chemical toxic agents.

However, these decontamination systems, although effective, need to be improved to ensure good reproducibility of the decontamination phase. Indeed, application in the form of gel, spray or pulverization does not allow for optimal and homogeneous dosage of decontaminating materials on the surfaces to be treated. In operating conditions, the user may not be sure that the amount of decontaminant applied is sufficient and will tend to apply more decontaminating materials than is actually necessary.

### OBJECT OF THE INVENTION

Thus, one of the aims of the present invention is to overcome at least one of the aforementioned drawbacks. To this end, the present invention provides a decontamination coating intended to trap toxic chemical compounds, such as G and V-type combat organophosphorus compounds, in particular by containment and sequestration, by covering a contaminated surface with the decontamination coating, the decontamination coating comprising a multilayer structure including:
a support, in particular a porous and flexible support,
a trapping layer formed on an upper face of the support, the trapping layer being intended to be brought into contact with the toxic chemical compounds so as to trap them, for example by adsorption and/or by a chemical degradation reaction, and
a holding film secured to a lower face of the support, opposite the upper face, the holding film being intended to maintain the shape of the support in the plane and in a direction transverse to the plane, during the formation of the trapping layer.

Thus configured, the decontamination coating ensures easy use and reproducible and reliable decontamination results. Thanks to the presence of the support, the active substance can be deposited under reproducible conditions and in reproducible amounts, to be used in the form of an already pre-prepared layer. The presentation of the active substance in a multilayer structure makes it possible to adequately cover a contaminated surface, in particular by allowing contact with the entire contaminated surface. The amounts and nature of the constituent materials are thus optimized for optimal efficiency, in particular by containing or sequestering the organosphorous compounds.

The use of the decontamination coating comprises a simple contact made by arranging the decontamination coating on the surface to be decontaminated, whereby said surface is very quickly depleted, or even devoid of the above-mentioned contaminants.

By the sentence “the holding film is intended to maintain the shape of the support in the plane and in a direction transverse to the plane”, it is understood that the holding film makes it possible to prevent deformations of the support in the plane and in a direction transverse to the plane.

According to one possibility, the holding film is a hydrophobic film so as not to adhere to the surfaces on which the decontamination coating is arranged during its manufacture, and during handling in the phase of placing the coating on the surfaces to be decontaminated.

The holding film is, for example, a Teflon or silicone film. This also allows the decontamination coating to be rolled up on itself, for packaging and on-site transport.

According to one arrangement, the trapping layer is a hydrogel layer formed by:
deposition of a precursor solution of the trapping layer, on the upper face of the support, and
polymerization of the precursor solution,
the precursor solution comprising at least one protic solvent, such as water, at least one monomer comprising an (alkyl)acrylic, (alkyl)acrylate or (alkyl)acrylamide group, at least one crosslinking agent comprising at least two groups selected from (alkyl)acrylic, (alkyl)acrylate or (alkyl)acrylamide groups, at least one photopolymerization initiator and at least one agent selected from alkali halides, alkali phosphates, alkali sulfates and mixtures thereof.

Thus, the trapping layer resulting from the polymerization of the monomer(s) and the crosslinking agent(s) defined above traps within it a liquid phase comprising an aforementioned agent. When the liquid phase comprises water, as a protic solvent, the above-mentioned polymeric material can be described as a hydrogel material.

In other words, the hydrogel material is a material in the form of a gel consisting of a polymer in which an aqueous phase is retained, which classically corresponds to the polymerization medium (that is to say the medium in which the polymerization took place to form the polymer constituting the hydrogel material), which absorbed, in our case, the organophosphorus compounds. Due to the flexibility of the polymer network constituting the hydrogel, such a material is classically capable of absorbing a mass of water that can exceed 100 times the mass of the polymer structure and, in our case, at least 5 times the mass of the polymer structure.

The step of forming the hydrogel layer can be carried out by applying radiation initiating the photopolymerization thanks to the action of photopolymerization initiators otherwise called here crosslinking agent. This radiation can advantageously belong to the ultraviolet radiation range, that is to say radiation having at least one wavelength in the ultraviolet range, i.e. a wavelength between 350 nm and 420 nm. The intensity of the radiation can be between 1000 and 10,000 W/m2. The origin of the radiation can be natural (for example, exposure to natural sunlight) or artificial, such as, for example, radiation from a UV lamp. For example, an artificial light source that can be used in the context of the invention may be a UV lamp emitting a wavelength of 405 nm with a power of 9000 W/m2 applied towards the precursor solution deposited on the support.

The hydrogel layer serves as a containment material for the toxic chemical agents initially present on the surface to be decontaminated. It should also be noted that, due to the reactivity of the solution with organophosphorus compounds, the organophosphorus compounds trapped in the gel can be naturally degraded in situ.

By the term “solution” it is specified that it is a homogeneous liquid mixture of the above-mentioned ingredients, which means that they are all used in such a way as to be soluble in the practical solvent of the solution.

By “protic solvent”, it is specified that this refers to a polar solvent having at least one hydrogen atom likely to be involved in the formation of hydrogen bonds, an example of a protic solvent particularly advantageous for the invention being water, in which case the solution of the invention can be described as an aqueous solution.

The protic solvent, such as water, may be present in the precursor solution in an amount of 40 to 60% by volume relative to the total volume of the solution.

By (alkyl)acrylic group, (alkyl)acrylate group or (alkyl)acrylamide group, it is specified that this refers to respectively:
for the (alkyl)acrylic group, an acrylic group or an alkylacrylic group (meaning that an alkyl group is present on the carbon bearing the double bond and the —CO— group);
for the (alkyl)acrylate group, an acrylate group or an alkylacrylate group (meaning that an alkyl group is present on the carbon bearing the double bond and the —CO— group); and
for the (alkyl)acrylamide group, an acrylamide group or an alkylacrylamide group (meaning that an alkyl group is present on the carbon bearing the double bond and the —CO— group). An example of an (alkyl)acrylic group, (alkyl)acrylate group or (alkyl)acrylamide group is a (meth)acrylic group, a (meth)acrylate group or a (meth)acrylamide group, respectively.

An example of an (alkyl)acrylic group, (alkyl)acrylate group or (alkyl)acrylamide group is a (meth)acrylic group, a (meth)acrylate group or a (meth)acrylamide group, respectively.

As mentioned above, the precursor solution of the invention comprises at least one monomer comprising an (alkyl)acrylic group, an (alkyl)acrylate group or an (alkyl)acrylamide group, such a monomer may have the following formula (I):

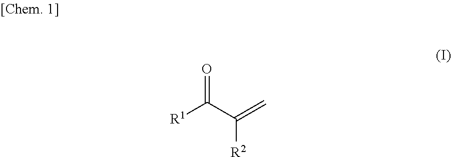

in which:
R₁ represents —OR′ with R′ representing a hydrogen atom or an alkali element (such as sodium or potassium); —OR₃ with R₃ representing an alkyl group, preferably, comprising from 1 to 4 carbon atoms (such as a methyl group, an ethyl group); or —NR₄R₅ with R₄ and R₅ representing, independently of each other, a hydrogen atom or an alkyl group, preferably, comprising from 1 to 4 carbon atoms (such as a methyl group, an ethyl group);
R₂ represents a hydrogen atom or an alkyl group, preferably, comprising from 1 to 4 carbon atoms (such as a methyl group, an ethyl group).

Advantageously, the monomer(s) of the invention comprise an (alkyl)acrylamide group, such as those having the following formula (II):

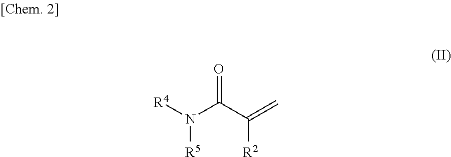

in which:
R₄ and R₅ are as defined above;
R₂ is as defined above.

In particular, it may be a monomer of formula (II), in which R₂ is a hydrogen atom and R₄ and R₅ represent a methyl group, such a monomer corresponding to N,N′-dimethylacrylamide.

The monomer(s) may be present in the precursor solution in an amount of 40 to 60% by volume relative to the total volume of the solution. For example, when the monomer is N,N′-dimethylacrylamide, it may be present in an amount of 47.8% by volume relative to the total volume of the precursor solution.

The precursor solution of the invention also comprises at least one crosslinking agent comprising at least two groups selected from the (alkyl)acrylic, (alkyl)acrylate, (alkyl)acrylamide groups, which means in other words that it is a compound comprising, for example:
at least two (alkyl)acrylic groups;
at least two (alkyl)acrylate groups;
at least two (alkyl)acrylamide groups;
at least one (alkyl)acrylic group and at least one (alkyl)acrylate group;
at least one (alkyl)acrylic group and at least one (alkyl)acrylamide group; or
at least one (alkyl)acrylate group and at least one (alkyl)acrylamide group.

Advantageously, the crosslinking agent(s) are agents comprising at least two (alkyl)acrylate groups, such as those having the following formula (III):

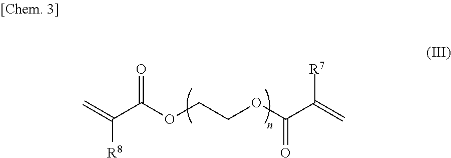

in which:
R₆ and R₇ represent, independently of each other, a hydrogen atom or an alkyl group, for example, comprising from 1 to 4 carbon atoms (for example, a methyl group, an ethyl group);
n corresponds to the number of occurrences of the unit in brackets, this number ranging from 1 to 15.

For example, a crosslinking agent which can be used in the precursor solution of the invention is an agent of formula (III), in which R₆ and R₇ are methyl groups, this agent thus corresponding to a polyethylene glycol dimethacrylate.

It is entirely possible to use several distinct crosslinking agents falling within the definition of agents of formula (III) defined above.

It is also understood that the crosslinking agents are distinct from the monomers used in the precursor solution of the invention.

In particular, a mixture of polyethylene glycol dimethacrylate with an average molar mass of 750 g/mol may be used, which corresponds to a mixture of several molecules of formula (III) defined above, with an average number of occurrences of the ethylene glycol unit of 13.2. The crosslinking agent(s) may be present in the precursor solution in an amount of 1 to 5% by volume relative to the total volume of the solution.

When it comes to the above-mentioned polyethylene glycol dimethacrylate mixture, this mixture may be present in the precursor solution in an amount of 1.6% by volume relative to the total volume of the solution.

Finally, the precursor solution comprises at least one photopolymerization initiator (which may also be called a photoinitiator), which initiator is a compound capable of generating free radicals, when subjected to suitable radiation (for example, UV radiation between 350 and 420 nm). The radicals thus formed will thus react with the reactive sites of the compounds present in the solution (here, the polymerizable functions of the monomers and the crosslinking agents) thus causing the polymerization of these compounds. This or these initiator(s) is/are, advantageously, solubilized by at least one of the constituent ingredients of the precursor solution (for example, the protic solvent).

The photopolymerization initiator(s) likely to be used in the precursor solution of the invention may be initiators from the aromatic ketone family, such as 1-hydroxy-cyclohexylphenylketone (also known under the trade names IRGACURE® 184 or CPK®) or (phenylphosphoryl)bis(mesitylmethanone) (known under the name IRGACURE®819) or a mixture of these two photoinitiators.

The photopolymerization initiator(s) may be present in the precursor solution in an amount of 1 to 15 g/L. For example, when the initiator is IRGACURE® 184, it may be present in an amount of 11.5 g/L.

Finally, the precursor solution comprises at least one agent selected from alkali halides, alkali phosphates, alkali sulfates and mixtures thereof.

The authors of the invention have found that these agents contribute to neutralizing organophosphorus compounds and, in particular, V-type combat organophosphorus compounds, which are compounds comprising a sulfur atom, which is connected to a phosphonate group, the above-mentioned agents being capable of cutting the phosphorus-sulfur bonds to accelerate their hydrolysis.

Furthermore, the above-mentioned agents make it possible to increase the ionic strength of the solution containing them, which makes it possible, among other things, to increase the sequestering power of the organophosphorus compounds by osmotic pressure.

The agent(s) may be present in the precursor solution in an amount of 1 to 30 g/L, preferably 1 to 15 g/L.

More specifically, the agent(s) may be selected from alkali fluorides, which alkali fluoride(s) may be present in the precursor solution in an amount of 1 to 15 g/L.

A particularly effective and usable agent in the precursor solution of the invention is potassium fluoride, which can be, for example, present in the solution in an amount of 11.5 g/L.

For example, the precursor solution of the invention may be composed exclusively of at least one protic solvent, at least one monomer including an (alkyl)acrylic, (alkyl)acrylate or (alkyl)acrylamide group, at least one crosslinking agent comprising at least two groups selected from (alkyl)acrylic, (alkyl)acrylate or (alkyl)acrylamide groups, at least one photopolymerization initiator and at least one agent selected from alkali halides, alkali phosphates, alkali sulfates and mixtures thereof.

A precursor solution in accordance with the invention is a solution comprising and/or which consists exclusively of the following ingredients:
as a protic solvent, water;
as a monomer, N,N′-dimethylacrylamide;
as a crosslinking agent, polyethylene glycol dimethacrylate or a mixture thereof;
as a photopolymerization initiator, 1-hydroxy-cyclohexylphenylketone (also known under the trade name IRGACURE® 184);
as an agent, potassium fluoride.

According to one possibility, the support is formed from at least one foamed polymer layer. This gives the support great flexibility so that the multilayer structure is also flexible and flat, making it easier to handle on the site to be decontaminated.

According to one arrangement, the support comprises an upper subsurface including a trapping layer portion impregnated into the support. This impregnation is obtained over a few tenths of a millimeter. This impregnation is beneficial as it helps to ensure securing between the support and the trapping layer. As will be seen later when describing the manufacturing method, this impregnation is obtained by depositing a viscous precursor solution of the trapping layer, by simple capillarity and gravity effect in the pores of the support prior to polymerization treatment.

According to one possibility, the support consists of a single polymer.

The upper subsurface consists of a portion of the thickness of the support below the upper surface and which has a thickness of less than 1 mm.

According to one arrangement, the support is formed of at least one polyurethane (PU) foam layer. The use of such a material is advantageous as it is inexpensive and its manufacture is obtained by a well-known method.

According to one embodiment, the support 1 comprises a polyester-based non-woven material.

According to one possibility, the support has a thickness between 1 and 10 mm, and in particular between 2 and 7 mm, depending on the maneuverability required for rolling up the decontamination coating and the desired mechanical strength.

According to a particular embodiment, the support is a multilayer assembly comprising an upper layer and an adsorbent lower layer, the adsorbent lower layer being capable of adsorbing the toxic chemical compounds. Thus, the increased thickness of this multilayer support makes it possible to increase the containability of the decontamination coating. Moreover, the lower layer completes the sequestration effect obtained with the toxic compound trapping layer by adsorbing any residual toxic compounds, in particular those present in gas form. This lower layer is thus capable of containing toxic compounds.

According to one possibility, the multilayer assembly comprises polyurethane foam.

According to one arrangement, the subsurface of the upper layer of the multilayer assembly is impregnated with a trapping layer portion.

According to one possibility, the lower adsorbent layer comprises and/or consists of a polyurethane foam layer impregnated with a porous adsorbent material.

According to one arrangement, the adsorbent material comprises and/or consists of activated carbon.

According to one possibility, the decontamination coating comprises a bonding film between the lower adsorbent layer and the upper layer. Thus, both layers of the support are securely held together.

According to one arrangement, the bonding film is formed from at least one polyolefin-type polymer material which is hot-melt at a temperature above 130° C. The nature of the bonding film makes it possible to bond the lower layer and the upper layer simply and effectively by applying heat to promote adhesion.

According to other features, the decontamination coating of the invention includes one or more of the following optional features considered alone or in combination:
The holding film is secured to the lower face of the support through an adhesive film.
The adhesive film comprises or consists of a material derived from acrylic polymers.
The thickness of the adhesive film is less than or equal to 1 mm.
The trapping layer has a thickness between 1 and 4 mm, and in particular between 1.5 and 3 mm.
The support is single-layer.
The polyurethane foam support comprises mostly open pores.
PU foam is obtained from a mixture of polyols and isocyanates.
The thickness of the impregnation with the trapping layer of the upper subsurface of the support is a few tens of nanometers.
The PU foam of the lower layer is identical to the PU foam of the upper layer in the two-layer assembly.
The PU foam has a density between 15 and 40 kg/m3 so as to give the coating the necessary maneuverability for its use and packaging in the rolled-up position.
The support is a two-layer assembly formed of an upper layer, an adsorbent lower layer and a bonding film.
The lower adsorbent layer has a thickness between 0.5 and 3 mm.
The upper layer has a thickness between 1 and 4 mm, for example between 1 and 3 mm.
The weight per unit area of activated carbon in the lower adsorbent layer is between 50 and 500 g/m².
The hot melt material of the bonding film is selected from a polyester material, a polyamide material and/or a combination of these materials.

According to a second aspect, the invention provides a decontamination assembly comprising the decontamination coating as previously described and a packaging device for preserving the decontamination coating, the packaging device being formed by a multilayer assembly comprising at least one aluminum layer and one PET (PolyEthylene Terephthalate) layer.

Thus configured, the packaging device makes it possible to store the decontamination coating away from light for protection against UV rays, hermetically to prevent moisture penetration and without adhering to the decontamination coating to avoid damaging it. It is then possible to guarantee several months' preservation of the decontamination coating.

According to one possibility, the packaging device is configured to be heat-sealable. This makes it possible to introduce the decontamination coating and then hermetically seal it.

According to one variant, the packaging device is provided with a hermetic ZIP closure.

According to one arrangement, the packaging device comprises three or four laminated layers, said layers are made of aluminum and PET.

For example, a packaging device for the decontamination assembly according to the invention comprises 12 microns of external polyester (PET), 12 microns of aluminum (central) and 75 microns of internal polyethylene.

Tests carried out with a three-layer packaging device as described have in fact shown that this packaging device makes it possible to preserve the decontamination coating for a year without aging, and therefore without loss of its trapping properties.

According to a third aspect, the invention provides a method for manufacturing the decontamination coating as previously described, the method comprising the following steps:
a) providing a holding film,
b) securing the lower face of the support to the holding film,
c) depositing a precursor solution of the trapping layer on the upper face of the support,
d) photopolymerization of the precursor solution so as to obtain the trapping layer.

According to one possibility, securing the lower face of the support to the holding film is obtained through the adhesive film previously deposited on the holding film.

The deposition of the precursor solution on the upper face according to step c) is carried out so as to generate an impregnation of the precursor solution on the upper subsurface of the support to form in step d) a trapping layer portion impregnated into the support. This arrangement reinforces the adhesion between the support and the trapping layer.

According to one possibility, the deposition of the precursor solution is carried out by coating on the support. Depending on the viscosity of the precursor solution, the solution penetrates into the upper subsurface of the support. For example, it penetrates a few tenths of a millimeter of the support's thickness so as to achieve securing of both layers, in particular for ease of use but also to be able to roll the coating up on itself during a packaging phase.

According to one arrangement, the photopolymerization of the precursor solution is carried out by radiation, in particular by ultraviolet radiation, that is to say having a wavelength in the ultraviolet range, i.e. a wavelength between 350 and 420 nm. The intensity of the radiation can be between 1000 and 10,000 W/m².

According to one possibility, the method comprises a step i) carried out prior to step b) of providing a polyurethane foam support comprising a two-layer assembly obtained by bonding through a bonding film between a lower adsorbent layer and an upper layer.

According to one possibility, the method comprises, prior to step i), a step j) of immersing the lower foamed polymer layer in an aqueous activated carbon solution comprising a binder and a thickener so as to form the lower adsorbent layer after drying.

According to one possibility, step j) is repeated a second time on the lower layer impregnated with activated carbon after drying in order to increase its adsorption capacity according to the targeted needs.

According to one arrangement, the manufacturing method comprises a step e) consisting in rolling the coating up on itself, the trapping layer being in contact with the holding film, surfaces in direct contact, for packaging purposes, in particular in the previously described packaging device.

### BRIEF DESCRIPTION OF THE DRAWINGS

Other aspects, purposes and advantages of the present invention will better appear on reading the following description of two embodiments thereof, given as a non-limiting example and made with reference to the appended drawings. The figures do not necessarily respect the scale of all the elements represented so as to improve their readability. In the following description, for simplicity, identical, similar or equivalent elements of the different embodiments bear the same numerical references.

FIG. 1 illustrates a schematic view of a cross-section of a decontamination coating according to a first embodiment of the invention.

FIG. 2 illustrates a schematic view of the decontamination coating in a position rolled up on itself in preparation for packaging.

FIG. 3 illustrates a schematic view of a cross-section of a decontamination coating according to a second embodiment of the invention.

### DETAILED DESCRIPTION

In the figures and in the following description, the same references represent identical or similar elements. Moreover, the different elements are not shown to scale so as to enhance the clarity of the figures. In addition, the different embodiments and variants are not mutually exclusive and may be combined with each other.

Unless otherwise stipulated, the term “substantially” means, in the present document, “exactly or to within 10% or 10°”.

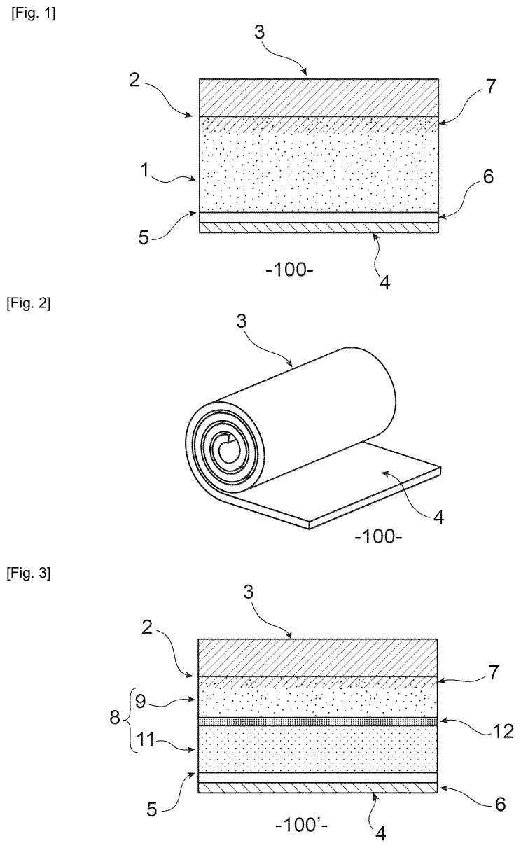

As illustrated in FIG. 1, the decontamination coating 100 comprises a support 1 on the upper face 2 of which is formed a trapping layer 3 and a holding film 4 secured to the lower face 5 of the support 1 through an adhesive film 6. The support 1 comprises a porous material layer obtained by a foamed polymer such as a polyurethane foam. The support 1 may also be a polyester-based non-woven material capable of fulfilling the same role in the decontamination coating 100 as a polyurethane foam. The support 1 is sufficiently flexible to be able to roll up on itself (refer to FIG. 2), even once secured to the trapping layer 3 and to the holding film 4, which facilitates its packaging, in particular when it is manufactured in the form of a continuous strip.

The trapping layer 3, intended to be brought into contact with the toxic contaminants, is formed by coating on the upper surface 2 of the support 1. The trapping layer 3 is in the form of a hydrogel obtained by photopolymerization of a precursor solution comprising:
at least one monomer comprising an (alkyl)acrylic, (alkyl)acrylate or (alkyl)acrylamide group,
at least one crosslinking agent comprising at least two groups selected from (alkyl)acrylic, (alkyl)acrylate or (alkyl)acrylamide groups,
at least one photopolymerization initiator
and at least one agent selected from alkali halides, alkali phosphates, alkali sulfates and mixtures thereof, all of which being diluted in a protic solvent, such as water.

The precursor solution is deposited by coating and penetrates into the upper subsurface of the porous support 1 over a few tenths of a mm, by simple gravity, the time required to carry out the photopolymerization. This generates the formation of a trapping layer 3 portion 7 impregnated into the support 1, which allows good adhesion between the latter and the trapping layer 3.

The holding film 4 is adhered to the lower face 5 of the support 1 prior to coating with the precursor solution so as to complete and achieve the rigidity required for the support 1 so that it retains its shape (layer extending in a plane and including at least two parallel sides) and its flatness during the steps of forming the trapping layer 3.

FIG. 3 illustrates a decontamination coating 100′ according to the second embodiment of the invention. It differs from the previous one in particular in that the support 1 comprises a polyurethane foam-based two-layer assembly 8, having an upper layer 9 on which the trapping layer 3 is formed and a lower adsorbent layer 11 bonded to the upper layer 9 through a hot-melt bonding film 12. The lower adsorbent layer 11 is a polyurethane foam-based layer impregnated with activated carbon. This configuration is in particular configured to improve decontamination in the presence of contaminating compounds that are more volatile or at least capable of migrating through the thickness of the decontamination coating 100, 100′.

The invention will now be described in light of the examples below, these examples being provided only as an illustration of the invention and in no way constituting a limitation thereof.

Decontamination tests are thus carried out by the French Directorate General for Armaments (DGA) using samples 200, 200′ of both types of decontamination coating 100, 100′ (without and with activated carbon) against organophosphorus combat gases, according to the recommendations of the standard AEP-65 (NATO standard), adapted in particular to the specificities of the samples 200, 200′.

Samples 200, 200′ with a surface area of 5×5 cm² and comprising a thickness between 3 and 4 mm are removed from their packaging just before carrying out the decontamination tests.

An example of preparing a precursor solution of a trapping layer 3 in accordance with one embodiment of the invention is described below.

In a 30 ml pill organizer, previously dried in an oven overnight at 90° C. under dynamic vacuum and packaged under argon, 10.4 mL of N,N′-dimethylacrylamide, 11.0 ml of distilled water, 0.35 mL of poly(ethylene glycol)dimethacrylate with an average molar mass of 750 g/mol, 0.25 g of IRGACURE® 184 and 0.25 g of potassium fluoride are introduced successively.

A magnetic stir bar is introduced into the resulting medium. The medium is then purged with argon and magnetically stirred until the solid compounds, such as IRGACURE® 184 and potassium fluoride, are completely dissolved.

The precursor solution is deposited by coating on the upper surface 2 of the support 1,8. Complete gelation of the precursor solution is achieved after 9 minutes of exposure with a UV lamp emitting a wavelength of 405 nm with a power of 9000 W/m². The hydrogel thus formed makes it possible to obtain the decontamination coatings 100, 100′.

At the same time, the contaminating compounds are arranged on a HDPE (High Density Polyethylene) support, having a flat surface. Once the supports are contaminated, they are arranged in a hermetic enclosure that is temperature-controlled at approximately 30° C. for 90 minutes.

Then, the decontamination coating 100, 100′ is placed on the surface of the contaminated support while exerting pressure (20 g/cm2) and the assembly maintained under pressure is placed for 1 hour in a temperature-controlled enclosure at approximately 30° C.

The decontamination coating 100,100′ is then placed in a solvent so as to dissolve the contaminating compounds that the decontamination coating 100,100′ has trapped. The solvent solution is then analyzed by gas/liquid chromatography depending on the contaminant in order to perform the calculations of the amount of contaminant trapped in the decontamination coating 100,100′.

These tests are repeated five times for each of three toxic organophosphorus chemical compounds (compounds A, B and C) and this with a sample 200 of the decontamination coating 100 without activated carbon, a sample 200′ of the decontamination coating 100′ with activated carbon and with a decontamination layer comprising only the material of the trapping layer 3 (which will be called the hydrogel coating hereinafter).

The results of these tests illustrated in table 1 below report the decontamination efficiency of sample 200 with respect to the hydrogel coating alone (for the same natures of material of the trapping layer) and the decontamination efficiency of sample 200′ with respect to the hydrogel coating alone (refer in particular to document EP3740514 for the application of the hydrogel alone).

TABLE 1

| | Rate of | Rate of | Rate of |
|---|---|---|---|
| | improvement of | improvement of | improvement of |
| | decontamination | decontamination | decontamination |
| Considered | with respect to | with respect to | with respect to |
| coatings | Compound A | Compound B | Compound C |
| Sample 200/ | 97.00% | 65.00% | 63.00% |
| hydrogel | | | |
| coating only | | | |
| Sample 200′/ | 100.00% | 88.00% | 94.00% |
| hydrogel | | | |
| coating only | | | |

The decontamination tests carried out show that the decontamination coatings 100 (sample 200), 100′ (sample 200′) are more effective than the use of a hydrogel coating alone (for example, 97% improvement of decontamination is observed between sample 200 and the hydrogel coating alone with respect to compound A). The decontamination coating 100′ comprising activated carbon is particularly effective for decontaminating organophosphorus contaminants present on a smooth support.

In addition, after one year's packaging of samples 200, 200′ of decontamination coatings 100, 100′ in the previously described packaging devices, the test results show the same level of decontamination. It is thus possible to conclude that the trapping layer 3 does not undergo aging over this period under these packaging conditions.

Thus, the present invention provides highly effective decontamination coatings against toxic chemical compounds, in particular organosphorus compounds, which are stable over time and simple to manufacture, in particular in the form of a strip which can be cut according to the desired uses.

1. A decontamination coating intended to trap toxic chemical compounds, by covering a contaminated surface with the decontamination coating, the decontamination coating comprising a multilayer structure including:
a support,
a trapping layer formed on an upper face of the support, the trapping layer being intended to be brought into contact with the toxic chemical compounds so as to trap them, and
a holding film secured to a lower face of the support opposite the upper face the holding film being intended to maintain the shape of the support in the plane and in a direction transverse to the plane, during the formation of the trapping layer.

2. The decontamination coating according to claim 1, wherein the trapping layer is a hydrogel layer formed by:
deposition of a precursor solution of the trapping layer, on the upper face of the support, and
polymerization of the precursor solution,
the precursor solution comprising at least one protic solvent, at least one monomer comprising an acrylic, acrylate or acrylamide group, at least one crosslinking agent comprising at least two groups selected from acrylic, acrylate or (alkyl)acrylamide groups, at least one photopolymerization initiator and at least one agent selected from alkali halides, alkali phosphates, alkali sulfates and mixtures thereof.

3. The decontamination coating according to claim 1, wherein the support is formed from at least one foamed polymer layer.

4. The decontamination coating according to claim 1, wherein, the support comprises an upper subsurface including a trapping layer portion impregnated into the support.

5. The decontamination coating according to claim 1, wherein the support is formed from at least one polyurethane foam layer.

6. The decontamination coating according to claim 1, wherein the support is a multilayer assembly comprising an upper layer and a lower adsorbent layer the lower adsorbent layer being capable of adsorbing toxic chemical compounds.

7. The decontamination coating according to claim 6, wherein the lower adsorbent layer comprises at least one polyurethane foam impregnated with an adsorbent porous material.

8. The decontamination coating according to claim 7, wherein the adsorbent porous material comprises activated carbon.

9. The decontamination coating according to claim 6, which comprises a bonding film between the lower adsorbent layer and the upper layer.

10. A decontamination assembly comprising the decontamination coating according to claim 1 and a packaging device for preserving the decontamination coating, the packaging device being formed by a multilayer assembly comprising at least one aluminum layer and one PET (PolyEthylene Terephthalate) layer.

11. A method for manufacturing the decontamination coating according to claim 1, the method comprising the following steps:
a) providing a holding film,
b) securing the lower face of the support to the holding film,
c) depositing a precursor solution of the trapping layer on the upper face of the support, and
photopolymerization of the precursor solution so as to obtain the trapping layer.
